(19) United States
(12) Patent Application Publication
(10) Pub. No.: US 2009/0028150 A1
(43) Pub. Date: Jan. 29, 2009

(54) Protocol-Independent Packet Header Analysis

(75) Inventors: Petter Johnsen, Arendal (NO); Ken Barnett, Cary, NC (US); Jeremy Henson, Durham, NC (US)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 11/829,015

(22) Filed: Jul. 26, 2007

(51) Int. Cl. H04L 12/56

(52) U.S. Cl. 370/392

(57) ABSTRACT

Analyzing a packet header in a data communications system involves using a descriptor mask to control selective comparison between one or more bits of the packet header and one or more bits of a session descriptor. Setting a mask bit to one state indicates that a comparison between a corresponding bit of a received packet header and a corresponding bit of a session descriptor should be performed, whereas setting the mask bit to an alternative state indicates that no comparison should be performed. A comparison result is generated that indicates whether all of the one or more bits of the packet header match corresponding ones of the one or more bits of the first session descriptor. The descriptor mask and session descriptor are programmable, so that the comparison hardware design is protocol-independent.

### BACKGROUND

The present invention relates to analysis of packet headers in data communication networks.

In packet-based data communication networks, information is efficiently and reliably communicated in the form of packets. Packets typically comprise three portions: a header, a payload, and a trailer. The header typically includes addressing information (i.e., identifying the intended destination of the packet) as well as other information about the packet (e.g., information about its length, which part of a multi-part communication this packet represents, and information that allows the recipient to detect and possibly correct errors in the received packet). The payload is the information to be communicated, and the trailer marks the end of the packet and may include additional information for handling the received data block.

In packet-based data communication networks, header analysis is a necessary function for properly routing packets within a system (i.e., to system software applications/services, to other communications interfaces, or to a data storage device). Because the speed of this header analysis affects the rate of communication, many systems include dedicated subsystems analyzing packet headers quickly.

A common task for header analysis is the analysis of immutable fields for a given session (i.e., source/destination addresses, ports) rather than mutable fields (i.e. error checking codes, sequence numbers). Since the contents of immutable fields are identical for all packets within a given session, these fields may be used to compare an incoming header to known ongoing data communication sessions and use this comparison to route the data within the system.

This type of header analysis of data communication packets can be accomplished in various ways, including both software and digital hardware solutions. A software solution provides a flexible and upgradeable approach. It is often adaptable as system requirements change and when it becomes necessary to support new protocols with differing header formats. Hardware solutions often sacrifice these traits, but improve the analysis throughput, thereby allowing for an increased data rate as compared to a software only solution.

The shortcomings of the software solutions are related to available microprocessor resources within a system. Systems often contain a limited number of microprocessors and try to perform many processing tasks concurrently. In such systems, tasks that can be reduced to simple and consistent operations are often migrated to a custom digital hardware solution to free the general purpose microprocessor resource for other tasks.

Historically the major shortcoming of hardware based header analysis is that it is less future proof than an adaptable software approach because hardware designs require that the hardware be protocol aware. Once implemented, these protocol specific aspects cannot be changed. For example, consider the need to identify the locations of certain fields within a header, as required for comparison to ongoing data communication sessions. A design created to support specific protocols with either the locations or sizes of the fields of interest being fixed in hardware can be made obsolete by protocol changes or if unanticipated options for the protocol require support.

To take just one of many possible examples of a protocol option that could render a header analysis hardware module obsolete, consider the Internet Protocol Security Authentication Header (IPSec AH) option. To produce an authenticated IPSec transport mode packet, the AH header is inserted between the original Internet Protocol version 4 (IPv4) and Transmission Control Protocol (TCP) headers. If the original design of the hardware did not account for the optional AH header, then any hardware relying on fixed field locations and sizes would not be capable of supporting authenticated IPSec packets.

This specific example highlights the limitations of inflexible hardware solutions. It is difficult to know in advance all of the options and changes that may be needed in the future. This problem is further increased when data link layer protocol headers (e.g., headers in accordance with Ethernet, High-level Data Link Control—“HDLC”, or Point-to-Point Protocol—“PPP”) are expected to be analyzed in addition to the network and transport layer protocols.

It is therefore desirable to provide protocol-independent header analysis methods and apparatuses that reduce issues of hardware obsolescence.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters are provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in methods and apparatuses for analyzing a packet header in a data communications system. Such methods and apparatuses involve using a first descriptor mask to control selective comparison between one or more bits of the packet header and one or more bits of a first session descriptor. A first comparison result is generated that indicates whether all of the one or more bits of the packet header match corresponding ones of the one or more bits of the first session descriptor.

In another aspect, one or more other descriptor mask/session descriptors can be provided to enable completely different comparisons to be performed on the same received header. In still another aspect, the different comparisons can be performed concurrently, thereby achieving quick header analysis operations.

In still another aspect, the first descriptor mask comprises m bits, and using the first descriptor mask to control selective comparison between one or more bits of the packet header and one or more bits of the first session descriptor comprises using n of the m bits of the first descriptor mask to select which of n bits of the packet header will be bit-wise compared with respective ones of n bits of the first session descriptor, wherein n≦m. Further, generating the first comparison result that indicates whether all of the one or more bits of the packet header match corresponding ones of the one or more bits of the first session descriptor comprises asserting a match signal, wherein asserting the match signal is based, at least in part, on whether all of the selected ones of the n bits of the packet header are equal to the respective ones of n bits of the first session descriptor. In such embodiments, header analysis further comprises selecting a different group of n bits of the first descriptor mask and repeatedly

using n of the m bits of the first descriptor mask to select which of n bits of the packet header will be bit-wise compared with respective ones of n bits of the first session descriptor, and

asserting a match signal based, at least in part, on whether all of the selected ones of the n bits of the packet header are equal to the respective ones of n bits of the first session descriptor until all m bits of the first descriptor mask have been used.

In yet another aspect, in some embodiments in which n<m, asserting a match signal based, at least in part, on whether all of the selected ones of the n bits of the packet header are equal to the respective ones of n bits of the first session descriptor comprises asserting the match signal based on whether all of the selected ones of the n bits of the packet header are equal to the respective ones of n bits of the first session descriptor and whether an enable signal indicates that an earlier comparison asserted the match signal.

In still another aspect of some embodiments, using n of the m bits of the first descriptor mask to select which of n bits of the packet header will be bit-wise compared with respective ones of n bits of the first session descriptor comprises using n of the m bits of the first descriptor mask to individually control whether respective ones of n 1-bit comparator logic will operate in a first mode or in a second mode. In such embodiments, the match signal is asserted based, at least in part, on whether all n of the 1-bit comparator logic indicate equality between comparator inputs. Moreover, in such embodiments each of the 1-bit comparators receives for comparison one bit from the packet header and one bit from the first session descriptor; in the first mode of operation, each of the 1-bit comparators generates an output that indicates whether the one bit from the packet header is equal to the one bit from the first session descriptor; and in the second mode of operation, each of the 1-bit comparators generates an output that indicates equality between comparator inputs regardless of whether the one bit from the packet header is equal to the one bit from the first session descriptor.

In yet another aspect, in some embodiments in which n<m (i.e., so that the total number of bits to be compared exceeds the number that can be compared at any given time), the match signal is asserted based on whether all n of the 1-bit comparators indicate equality between comparator inputs and whether an enable signal indicates that an earlier comparison asserted the match signal.

### BRIEF DESCRIPTION OF THE DRAWINGS

The objects and advantages of the invention will be understood by reading the following detailed description in conjunction with the drawings in which:

FIG. 1 is a schematic diagram illustrating a session data set comprising a session descriptor and a session mask in accordance with aspects of the invention.

FIG. 2 is a flow diagram of exemplary steps/processes carried out by logic in accordance with aspects of the invention.

FIG. 3 is a block diagram of another exemplary embodiment comprising aspects of the invention.

FIG. 4 is a block diagram of an exemplary embodiment of comparator logic in which m-bit session data sets are compared with the incoming header data n-bits at a time (n≦m ).

FIG. 5 is a block diagram of an exemplary embodiment of one of the n-bit selective comparators illustrated in FIG. 4.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

Various aspects of the invention make possible a digital hardware module that can be programmed with data, herein called a session data set, that identifies the locations and contents of particular fields of a packet header for comparison with corresponding bits of a received packet header. In one aspect, the session data set comprises two types of data structures: a session descriptor and a session descriptor mask. The session descriptor stores the contents of the fields of interest while the descriptor mask defines which individual bits of the descriptor are valid for comparison and which are not. In this way, an existing hardware module adapted to use the session data set is still usable even when new fields and field contents arise; in such cases it is necessary only to generate corresponding new session descriptor masks.

Such a structure allows the software, which is working in coordination with this device, to retain the protocol aware aspects and to provide this information as needed to the hardware on a session-by-session basis. In this way protocol changes are supported in software and the hardware is sufficiently flexible to support the changes.

To facilitate the description, the exemplary embodiments described in detail below demonstrate the utility of the various inventive aspects for processing variants of the TCP/IP protocol suite including IPv4, IPv6, TCP or User Datagram Protocol (UDP) transport layer protocols, and IPSec functionality. However it should be understood that the various aspects of the invention are not limited to the functionality described in the herein-described embodiments. Rather, they are readily adaptable to other protocols in various layers of a given network protocol stack.

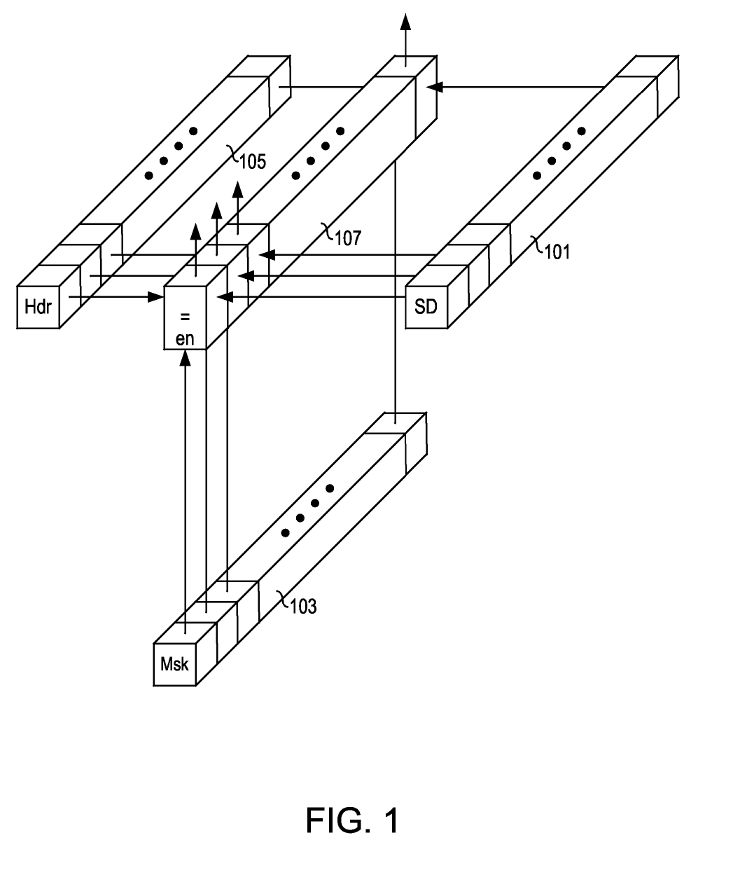

FIG. 1 is a schematic diagram illustrating a session data set comprising a session descriptor (SD) 101 and a session descriptor mask (Msk) 103, which are of equal size. Also illustrated is a packet header (Hdr) 105, which may or may not be the same length as the session descriptor 101 or mask 103.

In use, one session descriptor/mask pair is configured for each session (e.g., TCP/IP session) that requires acceleration by the hardware block. This configuration data can be configured on an ongoing basis, session-by-session, as needed based on the, for example, TCP/IP data. The session descriptor 101 is programmed to have particular values in fields of interest within the header 105. Further, each bit of the descriptor mask 103 indicates whether a corresponding bit of the header 105 is to be compared with a corresponding bit of the session descriptor 101. This selective comparison can be performed in any of a number of ways. For example, the descriptor mask 103 could be applied to the header 105 in a Boolean “AND” operation (or equivalent) to zero-out the “don't care” positions within the header, and the resultant bits compared with the session descriptor 101 which has been pre-programmed to have, for example, zero's in each of the “don't care” bit positions. The individual comparison results would then be analyzed, and a match condition would be asserted only when all of the individual comparison results indicate a match.

Alternatively, and as illustrated in FIG. 1, each of the bits of the header 105 and each of the bits of the session descriptor 101 can be applied as inputs to comparator logic 107 comprising a plurality of one-bit comparators. Each of the one-bit comparators of the comparator logic 107 is designed such that a comparison is performed only when an “enable” control signal is asserted; otherwise, the output of that one-bit comparator indicates equality regardless of what data inputs are applied. In this case, each bit of the descriptor mask 103 serves as an “enable” control signal for a corresponding one of the comparator bits. As a result of this arrangement, only those bits that are of interest (as indicated by asserted values—for example a binary 1—in the descriptor mask 103) contribute to the comparison result between the session descriptor 101 and the header 105. The outputs of the one-bit comparators must be further analyzed (not shown) to determine whether all of the bits of interest matched.

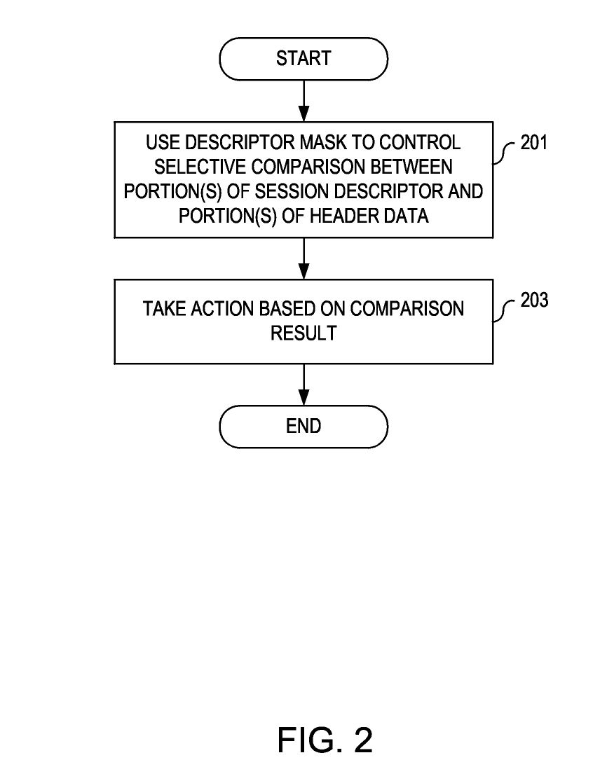

FIG. 2 is a flow diagram of exemplary steps/processes carried out by logic in accordance with aspects of the invention. As described earlier, a descriptor mask 103 is used to control selective comparison between one or more portions of a session descriptor 101 and corresponding portions of a header 105 (step 201). A comparison result indicates a “match” if all of the comparisons of interest indicated equality between the two inputs.

An implementation-dependent action can then be taken based on the comparison result (step 203).

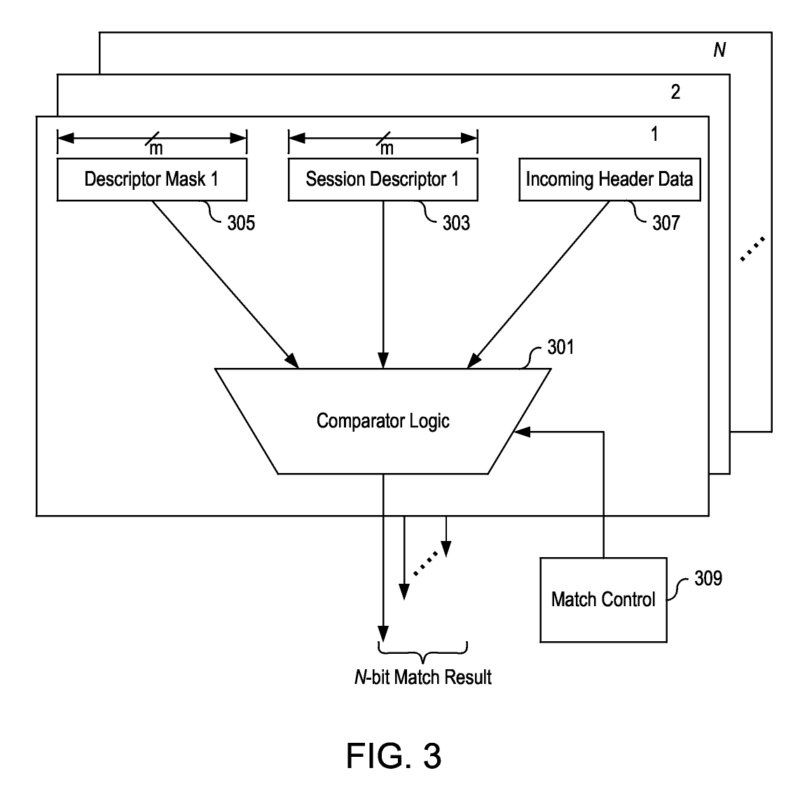

FIG. 3 is a block diagram of another exemplary embodiment comprising aspects of the invention. In this embodiment, it is desired to quickly ascertain whether an incoming header matches any of a number, N, of session data sets. Each session data set is programmed to represent particular data located in particular fields of the header. It is important to understand that the various data sets need not be examining the same set of fields—different fields as well as different data occupying those fields can be defined in the various data sets.

To quickly perform the N comparisons, N sets of comparator logic 301 are provided. For example, N=10 is a useful number of sets, although other embodiments can be designed to perform a different number of concurrent comparisons. Each comparator is provided with a corresponding one of N session data sets (i.e., N session descriptors 303, and N descriptor masks 305). Each of the N sets of comparator logic 301 receives its corresponding session descriptor 303, corresponding descriptor mask 305 and the incoming header 307 as its input. Under the control of match control logic 309, the comparator logic generates an output that indicates whether the data in the fields of interest of the session descriptor 303 matched the corresponding data in the incoming header 307. If yes, a “match” signal is asserted.

Because N sets of comparator logic 301 operate concurrently, an N-bit match result is generated which can be used to quickly ascertain whether any matches were found, and if so, which one.

The N session descriptors and their associated masks are preferably made available for configuration by software. Each descriptor and each mask are a number, m, of bits (e.g., m=480 bits=60 bytes). As mentioned earlier, one session descriptor/mask pair is configured for each session (e.g., TCP/IP session) that requires acceleration by the hardware block. This configuration data can be configured on an ongoing basis, session-by-session, as needed based on the, for example, TCP/IP data.

The m-bit length of the descriptors and masks should be designed to provide adequate storage to uniquely describe each anticipated session. When TCP/UDP headers, IP headers, and headers for IPSec sessions are anticipated, m=480 bits=60 bytes is a useful value. In a number of embodiments, the header matching portion of the logic need not be protocol aware and only needs to determine whether an incoming header matches a configured session by performing a bitwise comparison between the incoming header and each descriptor/mask pair.

Preferably, the configured descriptors/masks should be mutually exclusive so that any incoming packet will match at most one session descriptor. If no header match occurs, processing of the current packet can be handled by software.

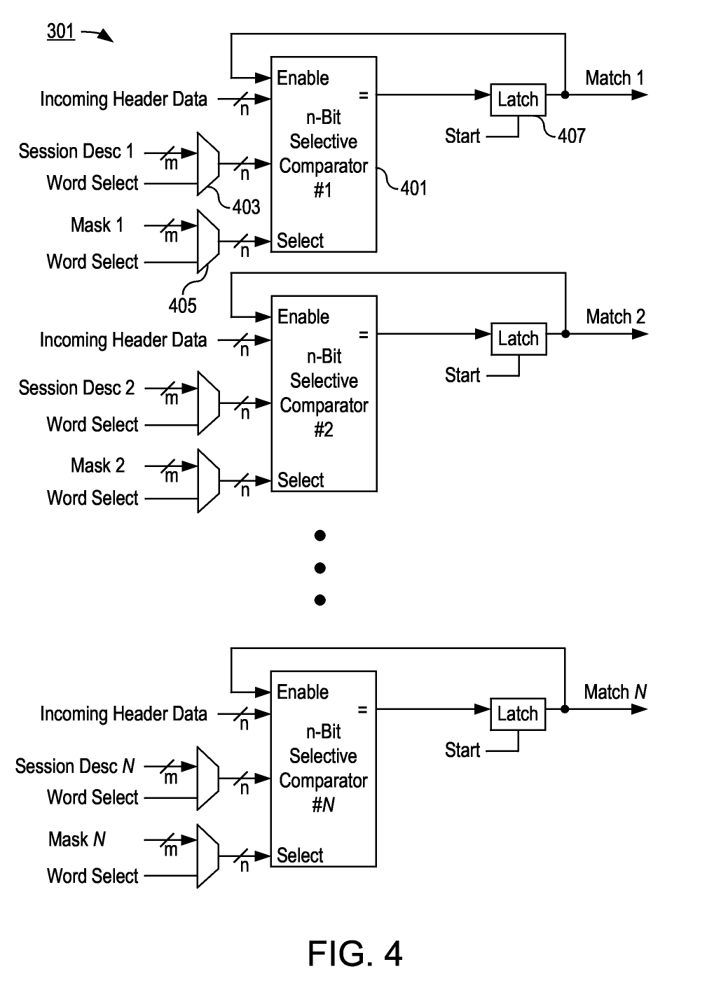

FIG. 4 is a block diagram of an exemplary embodiment of comparator logic 301 in which m-bit session data sets are compared with the incoming header data n-bits at a time (n≦m). For example, m=480 and n=32. N sets of n-bit selective comparators 401 are provided. Each n-bit selective comparator 401 operates as follows: Two n-bit operands are received at inputs along with an n-bit select control word and an enable control bit. If the enable control bit is not asserted, then the output of the n-bit selective comparator 401 is forced to indicate inequality between the inputs, regardless of whether an actual selective comparison between their values would indicate equality. The utility of this feature is described below.

If the enable control bit is asserted, then the output of the n-bit selective comparator 401 indicates whether the two n-bit operands are equal in all of the bit positions designated by the n-bit select control word. Values in other bit positions (i.e., those positions not designated by the n-bit select control word) do not contribute to the value of the output signal generated by the n-bit selective comparator 401.

In order to accommodate instances in which n is less than m, a first multiplexor 403 is provided for selecting an n-bit group of bits from the m-bit wide session descriptor, and a second multiplexor 405 is provided for selecting an n-bit group of bits from the m-bit wide descriptor mask. In each case, control of the multiplexors 403, 405 is derived from a word select signal that can be generated by the match control logic 309 mentioned earlier with respect to FIG. 3.

If more than n bits of the incoming header data are buffered at the time the n-bit comparison is ready to be performed, then a multiplexor similar to the multiplexors 403, 405 can be provided to select the n-bits of the incoming header data to take part in the next comparison. However, in this embodiment, it is assumed that comparison is performed as soon as n-bits of the incoming header data have been received. (As mentioned earlier, the incoming header data can be more than n-bits wide, but need not be the same size, m, as the session descriptor and descriptor mask). Accordingly, no multiplexor is needed for the incoming header data in this embodiment.

Because it will require m/n sequentially-performed comparison operations to generate a comparison result that is valid over the entire length of the session descriptor, this embodiment needs to ensure that a present equality between input operands does not erroneously generate a “match” result when an earlier comparison indicated an inequality. To satisfy this requirement, a latch 407 is provided that stores a last-generated output state from the n-bit selective comparator 401, and feeds this back as an enable signal to the enable input of the n-bit selective comparator 401. As mentioned earlier, the n-bit selective comparator 401 is designed such that it generates valid selective comparison results as described above whenever the enable signal is asserted (i.e., whenever the previously generated output from the n-bit selective comparator 401 indicated equality between the selected operand bits), but generates an output signal representing inequality whenever the enable signal is not asserted. In this way, any inequality detected at any one of the comparison operations is “remembered” throughout all subsequent comparisons until all m bits have been compared. For proper operation, a “start” signal initializes the output of the latch 407 to indicate a “match” condition to be feedback to the enable input of the n-bit selective comparator 401 for use during the first n-bit comparison operation. The start signal can be generated by, for example, the match control logic 309 discussed earlier.

As mentioned earlier, N of the n-bit selective comparators 401 and supporting logic are advantageously provided to allow N comparisons to be performed concurrently, thus greatly improving the speed of packet header analysis. However, in alternative embodiments, a serial implementation involving only one of the n-bit selective comparators 401 and supporting logic can be provided. While it would take longer to perform the desired N comparisons, this embodiment has the advantage of permitting the same comparison logic hardware to perform the comparison for each of the programmed descriptor/mask pairs.

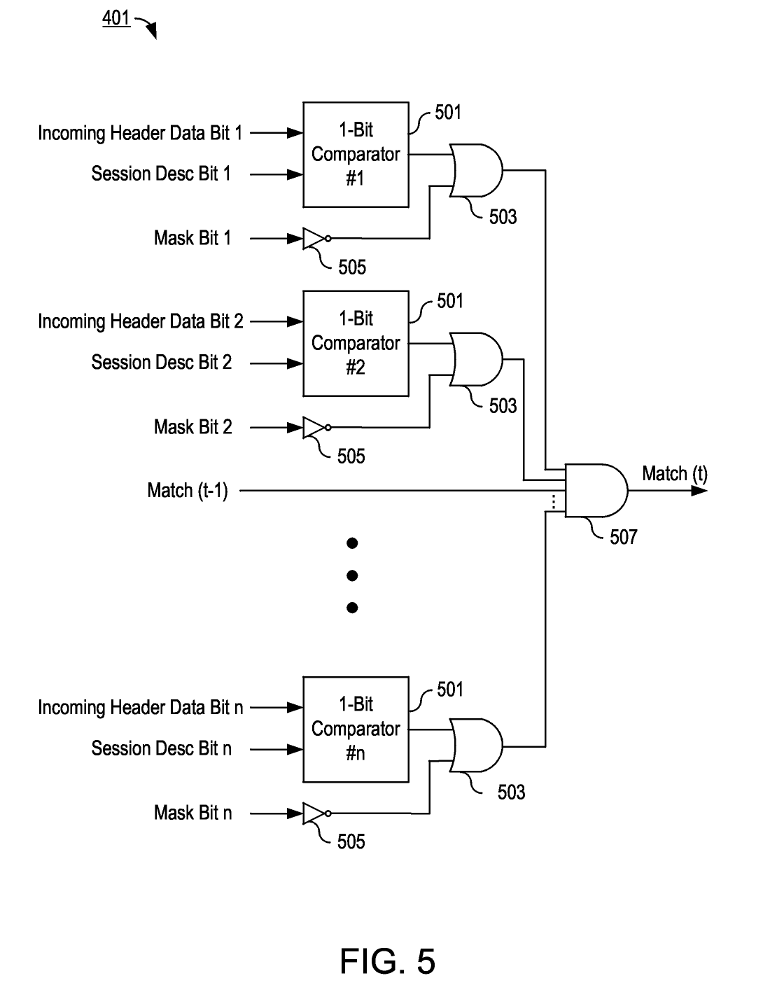

FIG. 5 is a block diagram of an exemplary embodiment of one of the n-bit selective comparators 401 discussed above with respect to FIG. 4. To facilitate ease of understanding, this embodiment assumes that, for each bit position in the descriptor mask, a binary 1 indicates that a first mode of operation should be performed in which the corresponding bit position of the incoming header data and the session descriptor are compared, whereas a binary 0 indicates that a second mode of operation should be performed in which no comparison of these bits should take place. It is further assumed that a “match” condition (indicating equality between all selected bits) is represented by a binary 1. Those of ordinary skill in the art will readily be able to adapt the logic to other binary representations of these meanings.

In this exemplary embodiment, each n-bit selective comparator 401 comprises n 1-bit comparators 501. Each 1-bit comparator can be implemented as, for example, and Exclusive NOR (XNOR) gate.

Each of the n bits of the incoming header data is supplied to a first operand input of a respective one of the n 1-bit comparators 501, and each of the n bits selected from the m-bit session descriptor is supplied to a second operand input of a respective one of the n 1-bit comparators 501.

Each 1-bit comparator 501 supplies its comparison result to a first input of a corresponding one of n OR gates 503. Each of the selected n bits of the m-bit descriptor mask is supplied to a corresponding one of n invertors 505, and each of the n resultant inverted signals is supplied to a second input of a corresponding one of the n OR gates 503. In alternative embodiments, the n invertors 505 can be eliminated by designing the logic so that in the descriptor mask, a binary “0” represents that a comparison should take place rather than a binary “1”. Returning to the example of FIG. 5, however, in operation a “0” bit supplied by the descriptor mask forces a “1” (i.e., equality) condition to be supplied at the output of the OR gate 503, whereas a “1” bit supplied by the descriptor mask causes a “0” to be supplied at the second input of the OR gate 503, thereby permitting the actual comparison result from the 1-bit comparator 503 to pass through to the output of the OR gate 503. It will thus be seen that each 1-bit comparator 501 in combination with a respective one of the OR gates 503 forms 1-bit comparator logic that is capable of operating in either of the first or second modes, depending on the value of the supplied bit from the descriptor mask.

The n outputs from the n OR gates 503 are supplied to corresponding ones of n inputs of an AND gate 507. Additionally, a signal representing the previous match decision (“Match(t−1)”), which can also be thought of as the “enable” signal described with respect to FIG. 4, is supplied to an n+1^{st} input of the AND gate 507. In this way, the output of the AND gate 507 (which represents the present match result) will be asserted only if each of the n outputs from the OR gates 503 is asserted along with the previous match result.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of analyzing a packet header in a data communications system, the method comprising:
a) using a first descriptor mask to control selective comparison between one or more bits of the packet header and one or more bits of a first session descriptor; and
b) generating a first comparison result that indicates whether all of the one or more bits of the packet header match corresponding ones of the one or more bits of the first session descriptor.

2. The method of claim 1, comprising:
c) using a second descriptor mask to control selective comparison between one or more bits of the packet header and one or more bits of a second session descriptor; and
d) generating a second comparison result that indicates whether all of the one or more bits of the packet header match corresponding ones of the one or more bits of the second session descriptor.

3. The method of claim 2, wherein steps a) and c) are performed concurrently.

4. The method of claim 1, wherein:
the first descriptor mask comprises m bits;
step a) comprises:
c) using n of the m bits of the first descriptor mask to select which of n bits of the packet header will be bit-wise compared with respective ones of n bits of the first session descriptor, wherein n <m;
step b) comprises:
d) asserting a match signal based, at least in part, on whether all of the selected ones of the n bits of the packet header are equal to the respective ones of n bits of the first session descriptor; and
the method comprises:
e) selecting a different group of n bits of the first descriptor mask and repeating steps c) and d) until all m bits of the first descriptor mask have been used.

5. The method of claim 4, wherein n<m and step d) comprises:
asserting the match signal based on whether all of the selected ones of the n bits of the packet header are equal to the respective ones of n bits of the first session descriptor and whether an enable signal indicates that an earlier comparison asserted the match signal.

6. The method of claim 4, wherein:
step c) comprises:
f) using n of the m bits of the first descriptor mask to individually control whether respective ones of n 1-bit comparator logic will operate in a first mode or in a second mode; and
step d) comprises:
g) asserting the match signal based, at least in part, on whether all n of the 1-bit comparator logic indicate equality between comparator inputs;
wherein:
each of the 1-bit comparator logic receives for comparison one bit from the packet header and one bit from the first session descriptor;
in the first mode of operation, each of the 1-bit comparator logic generates an output that indicates whether the one bit from the packet header is equal to the one bit from the first session descriptor; and
in the second mode of operation, each of the 1-bit comparator logic generates an output that indicates equality between comparator inputs regardless of whether the one bit from the packet header is equal to the one bit from the first session descriptor.

7. The method of claim 6, wherein n<m and step g) comprises:
asserting the match signal based on whether all n of the 1-bit comparator logic indicate equality between comparator inputs and whether an enable signal indicates that an earlier comparison asserted the match signal.

8. An apparatus for analyzing a packet header in a data communications system, the apparatus comprising:
a) logic configured to use a first descriptor mask to control selective comparison between one or more bits of the packet header and one or more bits of a first session descriptor; and
b) logic configured to generate a first comparison result that indicates whether all of the one or more bits of the packet header match corresponding ones of the one or more bits of the first session descriptor.

9. The apparatus of claim 8, comprising:
c) logic configured to use a second descriptor mask to control selective comparison between one or more bits of the packet header and one or more bits of a second session descriptor; and
d) logic configured to generate a second comparison result that indicates whether all of the one or more bits of the packet header match corresponding ones of the one or more bits of the second session descriptor.

10. The apparatus of claim 9, wherein elements a) and c) are concurrently operable.

11. The apparatus of claim 8, wherein:
the first descriptor mask comprises m bits;
element a) comprises:
c) logic configured to use n of the m bits of the first descriptor mask to select which of n bits of the packet header will be bit-wise compared with respective ones of n bits of the first session descriptor, wherein n≦m;
element b) comprises:
d) logic configured to assert a match signal based, at least in part, on whether all of the selected ones of the n bits of the packet header are equal to the respective ones of n bits of the first session descriptor; and
the apparatus comprises:
e) logic configured to select a different group of n bits of the first descriptor mask and repeatedly operate elements c) and d) until all m bits of the first descriptor mask have been used.

12. The apparatus of claim 11, wherein n<m and element d) comprises:
logic configured to assert the match signal based on whether all of the selected ones of the n bits of the packet header are equal to the respective ones of n bits of the first session descriptor and whether an enable signal indicates that an earlier comparison asserted the match signal.

13. The apparatus of claim 11, wherein:
element c) comprises:
f) a number, n, of 1-bit comparator logic configured to use n of the m bits of the first descriptor mask to individually control whether respective ones of the n 1-bit comparator logic will operate in a first mode or in a second mode, wherein n≦m; and
element d) comprises:
g) logic configured to assert a match signal based, at least in part, on whether all n of the 1-bit comparator logic indicate equality between comparator inputs;
wherein:
each of the 1-bit comparator logic receives for comparison one bit from the packet header and one bit from the first session descriptor;
in the first mode of operation, each of the 1-bit comparator logic generates an output that indicates whether the one bit from the packet header is equal to the one bit from the first session descriptor; and
in the second mode of operation, each of the 1-bit comparator logic generates an output that indicates equality between comparator inputs regardless of whether the one bit from the packet header is equal to the one bit from the first session descriptor.

14. The apparatus of claim 13, wherein n<m and element g) comprises:
logic configured to assert the match signal based on whether all n of the 1-bit comparator logic indicate equality between comparator inputs and whether an enable signal indicates that an earlier comparison asserted the match signal.
